(19) United States
(12) Patent Application Publication
(10) Pub. No.: US 2009/0125949 A1
(43) Pub. Date: May 14, 2009

(54) STREAM SUPPLYING APPARATUS, CONTENT REPRODUCING APPARATUS AND METHOD FOR REPRODUCING CONTENT

(75) Inventor: Yoshio Kimura, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/174,555

(22) Filed: Jul. 16, 2008

(30) Foreign Application Priority Data
Nov. 14, 2007 (JP) 2007-295965

(51) Int. Cl. H04N 5/445; H04N 7/173

(52) U.S. Cl. 725/59; 725/131

(57) ABSTRACT

A stream supplying apparatus includes: a tuner that receives a broadcast signal; a decoder that decodes the broadcast signal and outputs the decoded broadcast signal as a data stream; a memory that stores apparatus information that pertains to the stream supplying apparatus; and a network interface that transmits the apparatus information stored in the memory to a content reproducing apparatus, which is connected to the stream supplying apparatus via a network, in response to a state collecting command output from the content reproducing apparatus.

### CROSS-REFERENCE TO RELATED APPLICATIONS

This application is based upon and claims the benefit of priority from Japanese Patent Application No. 2007-295965, filed on Nov. 14, 2007, the entire content of which are incorporated herein by reference.

### BACKGROUND

1. Field

One embodiment of the present invention relates to a stream supplying apparatus, a content reproducing apparatus and a content reproducing method, which are preferable to be implemented as an audio/video equipment connected to a network.

2. Description of the Related Art

In recent years, a home network that is set up in private residences became widely used in accordance with popularization of digital equipments. By enabling transfer of digital data among various equipments, the digital data become capable to be handled in unified manner and enhance convenience of handling the digital data. For example, data can be transferred on a network that connects equipments, such as audio equipment and video equipment.

Since broadcast services become diversified, there is a case in which one or more receiver apparatuses are connected to a network for receiving contents of respective broadcast services. There is also a case in which a plurality of reproducing equipments are connected to the network, which reproduce and display a stream transferred from the receiver apparatuses connected to the network. Each of the reproducing equipments is capable of reproducing and displaying a program of a desired channel that is received by any one of the receiver apparatuses by allowing the user to select a target receiver apparatus and a receiving channel.

For example, a publication WO2005/011294 discloses an equipment that is capable of controlling other equipments connected to a network. The equipment disclosed in Patent Reference 1 determines a candidate of a target equipment that is connectable therewith on the network, and when a single target equipment exists, the equipment automatically establishes a connection with the target equipment and instruct the target equipment to be powered on.

However, with regard to a plurality of receiver apparatus connected on a network, a content of a service of whether which broadcasting mode of a signal can be received or the like cannot be determined by the reproducing apparatus. Further, even when an operation of switching a selected station channel cannot be performed as in a case of supplying a stream from a receiver apparatus has already been supplied to other reproducing apparatus, the reproducing apparatus cannot determine whether the receiver apparatus is available for receiving the broadcast signal.

As described above, in a conventional content reproducing system having a receiver apparatus (stream supplying apparatus) and a reproducing apparatus connected to a network, although the reproducing apparatus can determine whether or not the stream supplying apparatus is connected to the network, the reproducing apparatus cannot determine details of service provided by the receiver apparatus and whether the service is available. Accordingly, the conventional content reproducing system has a difficulty in improving convenience for allowing the user to view the desired program.

### SUMMARY

One of objects of the present invention is to provide a stream supplying apparatus, a content reproducing apparatus and a content reproducing method that allows the content reproducing apparatus to determine details of service and an availability of the service provided by the stream supplying apparatus that is connected to the content reproducing apparatus via a network.

According to a first aspect of the present invention, there is provided a stream supplying apparatus including: a tuner that receives a broadcast signal; a decoder that decodes the broadcast signal and outputs the decoded broadcast signal as a data stream; a memory that stores apparatus information that pertains to the stream supplying apparatus; and a network interface that transmits the apparatus information stored in the memory to a content reproducing apparatus, which is connected to the stream supplying apparatus via a network, in response to a state collecting command output from the content reproducing apparatus.

According to a second aspect of the present invention, there is provided a content reproducing apparatus including: a network interface that communicates via a network with a plurality of stream supplying apparatuses that output a data stream, the network interface receiving apparatus information that pertains to each of the stream supplying apparatuses from each of the stream supplying apparatuses; a storage that stores the apparatus information received by the network interface; a decoder that decodes the data stream received by the network interface to reproduce a content included in the data stream; and a controller that selects one of the stream supplying apparatuses based on the apparatus information stored in the storage and controls the network interface to receive the data stream output from the selected stream supplying apparatus.

According to a third aspect of the present invention, there is provided a content reproducing apparatus including: a network interface that communicates via a network with a plurality of stream supplying apparatuses that output a data stream, the network interface receiving apparatus information that pertains to each of the stream supplying apparatuses from each of the stream supplying apparatuses; a storage that stores the apparatus information received by the network interface; a decoder that decodes the data stream received by the network interface to reproduce a content included in the data stream; and a user interface that generates an image for notifying a status of the stream supplying apparatuses to a user based on the apparatus information stored in the storage.

According to a fourth aspect of the present invention, there is provided a method for reproducing content, the method including: communicating via a network with a plurality of stream supplying apparatuses that output a data stream to receive apparatus information that pertains to each of the stream supplying apparatuses from each of the stream supplying apparatuses; storing the received apparatus information; selecting one of the stream supplying apparatuses based on the stored apparatus information; receiving the data stream output from the selected stream supplying apparatus; and decoding the received data stream to reproduce a content included in the data stream.

According to a fifth aspect of the present invention, there is provided a method for reproducing content, the method including: communicating via a network with a plurality of stream supplying apparatuses that output a data stream to receive apparatus information that pertains to each of the stream supplying apparatuses from each of the stream supplying apparatuses; storing the received apparatus information; decoding the received data stream to reproduce a content included in the data stream; and generating an image for notifying a status of the stream supplying apparatuses to a user based on the stored apparatus information.

### BRIEF DESCRIPTION OF THE SEVERAL VIEWS OF THE DRAWINGS

A general configuration that implements the various feature of the invention will now be described with reference to the drawings. The drawings and the associated descriptions are provided to illustrate embodiments of the invention and not to limit the scope of the invention.

FIG. 1 is a block diagram showing a content reproducing system having a stream supplying apparatus and a content reproducing apparatus according to an embodiment of the present invention.

FIG. 2 is a block diagram showing a specific configuration of a content reproducing apparatus shown in FIG. 3.

FIG. 3 is an explanatory view showing an overall configuration of the content reproducing system.

FIG. 4 is an explanatory diagram showing an example of information stored in an apparatus information memory.

FIG. 5 is a flowchart for explaining an operation of the content reproducing system according to the embodiment.

FIG. 6 is an explanatory diagram for explaining the operation of the content reproducing system according to the embodiment.

FIG. 7 is an explanatory diagram for explaining the operation of the content reproducing system according to the embodiment.

FIG. 8 is an explanatory diagram for explaining the operation of the content reproducing system according to the embodiment.

FIG. 9 is an explanatory diagram for explaining the operation of the content reproducing system according to the embodiment.

### DETAILED DESCRIPTION

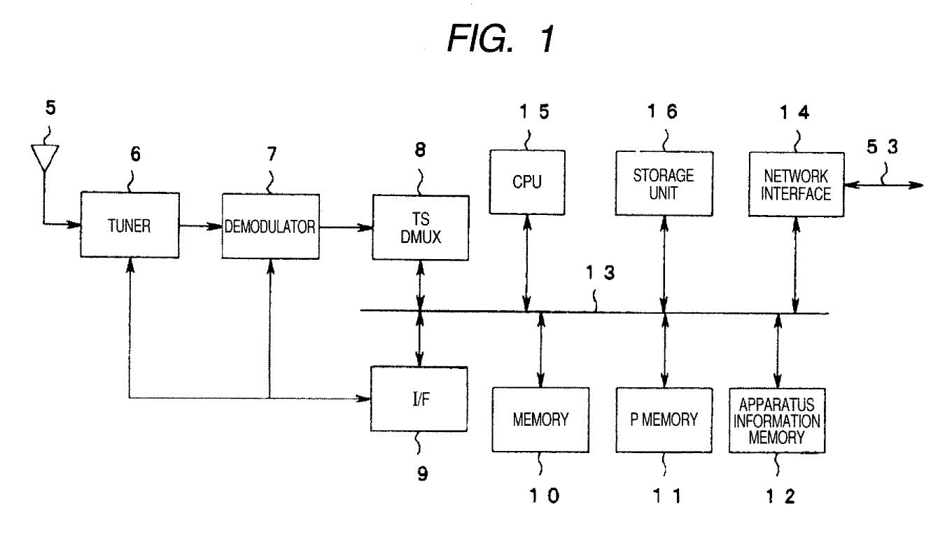

A detailed explanation will be given of an embodiment of the present invention with reference to the accompanying drawings. FIG. 1 is a block diagram showing a content reproducing system having a stream supplying apparatus and a content reproducing apparatus according to an embodiment of the present invention.

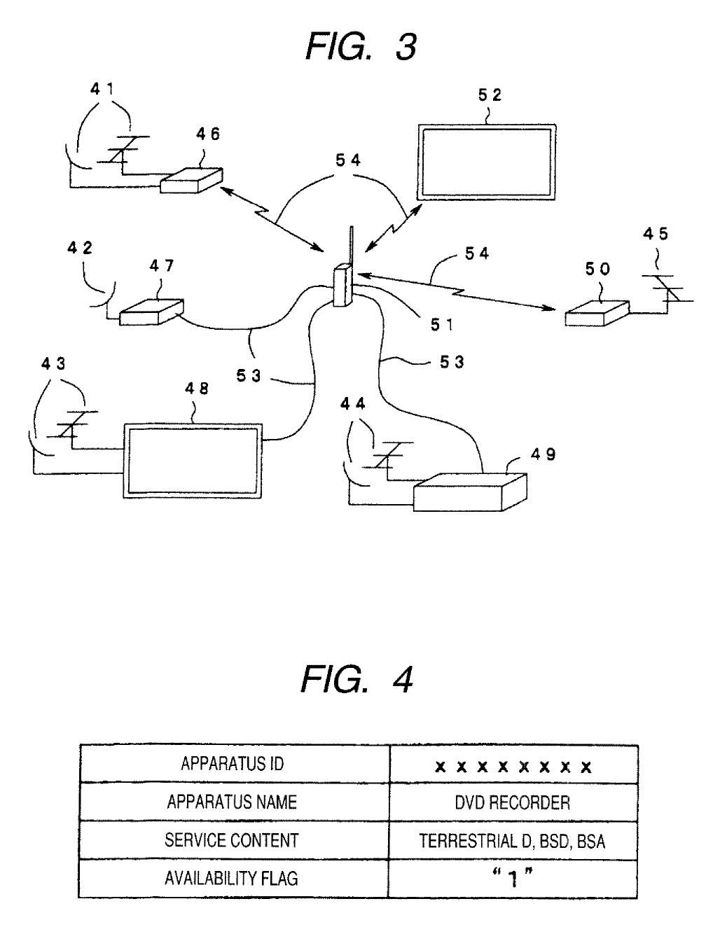

First, a overall configuration of a content reproducing system according to the embodiment will be explained with reference to FIG. 3. Stream supplying apparatus 46 through 50 and a content reproducing apparatus 52 are connected through a network. An example of FIG. 3 shows an example in which the stream supplying apparatus 46 through 50 and the content reproducing apparatus 52 are connected by a cable 53 or a wireless communication path 54 and a relay apparatus 51, which conform with a predetermined communication standard.

The stream supplying apparatus 46 serves as a receiver apparatus that receives terrestrial and satellite broadcast signals received by way of an antenna 41 and is made to be able to output a stream of a content by selecting a channel based on an operation of a user. The stream supplying apparatus 47 serves as a receiver apparatus that receives a CS broadcast signal received by way of an antenna 42 and is made to be able to output a stream of a content by selecting a channel based on the operation of the user. The stream supplying apparatus 48 is a television receiver apparatus for receiving terrestrial and satellite broadcast signals received by way of an antenna 43 and is made to be able to output a stream of contents (programs) by selecting a channel based on the operation of the user and visualize a content received on a display screen, not illustrated. The stream supplying apparatus 49 is a recorder for receiving and recording terrestrial and satellite broadcast signals by way of an antenna 44 and is made to be able to output a stream of a content by selecting a channel based on the operation of the user and record a content received by a storage unit, not illustrated. The stream supplying apparatus 50 is a receiver apparatus for receiving and recording a terrestrial broadcast signal received by way of an antenna 45 and is made to be able to output a stream of contents by selecting a channel based on the operation of the user.

The stream supplying apparatus 47 through 49 output the stream of the content received to acquire onto a network by way of the cable 53, and the stream supplying apparatus 46 and 50 are made to be transmit the stream of the content received to acquire onto the network by way of the wireless communication path 54. The relay apparatus 51 can relay a data flowing on the network by wire and wireless.

The content reproducing apparatus 52 designates an apparatus of inputting the stream of the content from the designated apparatus in the stream supplying apparatus 46 through 50 connected to the network and reproduces the stream of the content from the designated apparatus. The content reproducing apparatus 52 visualizes the reproduced content on a display portion, not illustrated, and outputs sound of the content by way of a speaker, not illustrated.

Further, although FIG. 3 shows an example of connecting five pieces of the stream supplying apparatus and one piece of the content reproducing apparatus, a number of pieces of connecting the stream supplying apparatus and the content reproducing apparatus cannot particularly be limited. Further, the relay apparatus 51 can be connected with various kinds of audio and video apparatus and the like. For example, STB (set top box) having a tuner function, recording apparatus and display apparatus of recording/reproducing DVD apparatus and the like can be connected thereto.

FIG. 1 is a block diagram showing a specific configuration of the stream supplying apparatus 46 through 50 in FIG. 3. The stream supplying apparatus 46 through 50 may be apparatus of receiving an analog broadcast signal and may be apparatus of receiving a digital broadcast signal. Further, in FIG. 1, an explanation will be given such that the stream supplying apparatus is an apparatus of receiving a digital broadcast signal and having a recording function.

An antenna 5 of FIG. 1 corresponds to the antennas 41 through 45. A digital broadcast signal induced in the antenna 5 is supplied to a tuner 6. The tuner 6 selects a channel designated by a user. A signal from the tuner 6 is provided to a demodulator 7. The demodulator 7 executes a demodulating processing for a modulating processing executed by a broadcast station. For example, the demodulator 7 recovers a transport stream (TS) before the modulating processing by executing an OFDM demodulating processing, a PSK demodulating processing or the like.

Further, in an example of FIG. 1, a circuit portion other than the tuner 6 and the demodulator 7 are formed by an integrated circuit. CPU 15 controls respective portions formed by the integrated circuit and controls the tuner 6 and the demodulator 7 by way of an interface (I/F) 9.

TSDMUX 8 basically outputs the transport stream input thereto without applying any change. When a plurality of contents (programs) are included in the input transport stream, the TSDMUX 8 separates the contents selected by the user from other contents and outputs the separated contents. In the circuit portion formed by the integrated circuit, a data is transferred by way of a bus 13. CPU 15 stores a stream from TSDMUX 8 to a memory 10 and reads the stream from the memory 10 to output to an network interface 17. The network interface 14 serves as an interface between the cable 53 provided in the network and respective portions at inside of a circuit formed into an integrated circuit. The network interface 14 is an interface conforming to a predetermined communication standard and executes communication by adopting, for example, TCP/IP protocol as a communication protocol. The network interface 14 outputs a data at inside of the integrated circuit onto the network and inputs a data to its own apparatus flowing in the cable 53 into the integrated circuit. The network interface 14 supplies a command transferred to its own apparatus by way of the cable 53 to CPU 15 and transfers a data from CPU 15 to a destination by way of the cable 53. Further, the network interface 14 is made to transfer the transport stream read from the memory 10 to a designation by way of the cable 53. In the embodiment, the demodulator 7 and the TSDMUX 8 serve as a decoder that decodes the broadcast signal and outputs the decoded broadcast signal as a data stream.

A storage unit 16 is made to be able to store the transport stream read from the memory 10 to a storage medium, not illustrated, by being controlled by CPU 15. Further, the storage unit 16 is made to be able to reproduce the transport stream recorded to the storage medium, not illustrated, to output onto the network by way of the network interface 14 by being controlled by CPU 15.

According to the embodiment, an apparatus information memory 12 is provided. The apparatus information memory 12 stores apparatus information that pertains to its own apparatus, the stream supplying apparatus. FIG. 4 is an explanatory diagram showing an example of information stored in the apparatus information memory 12. In an example of FIG. 4, it is shown that the apparatus information memory 12 retains information of ID of its own apparatus (apparatus ID), an apparatus name of its own apparatus, details of a service capable of outputting the stream and an availability flag. The apparatus ID is ID information capable of uniquely specifying its own apparatus on the network of FIG. 3. The apparatus name is a name for facilitating to differentiate the apparatus. The service content shows a kind of a signal of, for example, terrestrial broadcast by analog or digital, satellite broadcast, CS broadcast or broadcast by cable television, broadcast by the internet, or a reproducing signal from record media or the like. In the example of FIG. 4, it is shown that a stream of terrestrial digital broadcast (terrestrial D), BS digital broadcast (BSD) and BS analog broadcast (BSA) can be output. Further, as a service content, a specific channel number may be described.

The availability flag is a flag showing whether a stream can be output for a request for transferring the stream from outside, not illustrated, “1” indicates that the stream can be output and “0” shows that the stream cannot be output. For example, when the tuner constituting the stream supplying apparatus is brought into a standby state, the availability flag is “1” and when a broadcast is receiving the tuner, the availability flag becomes “0”. Further, when the stream supplying apparatus is a television receiver apparatus having 2 routes or more of tuners, even when a program of a predetermined channel is being viewed and heard in the television receiver apparatus, the stream can be output by using a tuner which is not used yet and in this case, the availability flag become “1”.

According to the embodiment, when state collecting command, mentioned later, is received, CPU 15 reads information of the apparatus information memory 12 and outputs the read apparatus information onto the network by way of the network interface 14 by constituting a destination by an origin of issuing the state collecting command. Further, a program memory (P memory) 11 is stored with a program for realizing a processing of CPU 15.

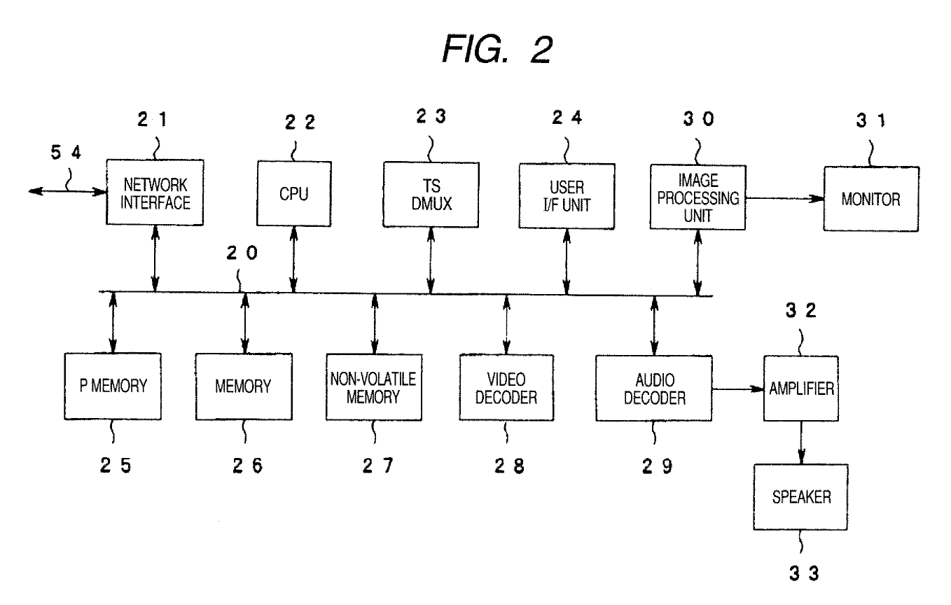

FIG. 2 is a specific configuration of the content reproducing apparatus 52 shown in FIG. 3. The content reproducing apparatus 52 may be an apparatus of reproducing an analog broadcast signal, or may be an apparatus of reproducing a digital broadcast signal. Further, an explanation will be given for the configuration shown in FIG. 2 assuming that the content reproducing apparatus 52 is an apparatus of reproducing a digital broadcast signal.

An network interface 21 serves as an interface between the wireless communication path 54 constituting the network and respective portions in a circuit formed by an integrated circuit. The network interface 21 supplies a data transferred by way of the wireless communication path 54 to CPU 22 by way of a bus 20 and transfers a command transferred from CPU 22 by way of the bus 20 to a destination by way of the wireless communication path 54. Further, the network interface 21 transfers the transport stream transferred by way of the wireless communication path 54 to a memory 26 to be temporarily stored.

In FIG. 2, a circuit portion other than a monitor 31, an amplifier 32 and a speaker 33 are formed by the integrated circuit, and CPU 22 controls respective portions brought into the integrated circuit. CPU 22 generates various commands to the respective stream supplying apparatus connected to the network, stores the transport stream read from the memory 26 to TSDMUX 23.

TSDMUX 23 separates the input transport stream into an image data and a voice data. The image data and the voice data are respectively supplied to a video decoder 28 or an audio decoder 29.

The video decoder 28 decodes the input image data and outputs an image signal to an image processing unit 30. The image processing unit 30 subjects an input image signal to various imaging processing of IP converting processing, image quality controlling processing and the like, thereafter, outputs the image signal to the monitor 31. In this way, a content based on the input stream is visualized on a display screen of the monitor 31. Further, the audio decoder 29 decodes an input voice data and outputs a voice signal to the amplifier 32. The amplifier 32 amplifies the input voice signal to output voice from the speaker 33.

As commands generated by CPU 22, there are, for example, start command for making a power source of the stream supplying apparatus ON, a command for controlling a receiving channel of the stream supplying apparatus (channel selecting request) and the like.

Further, according to the embodiment, CPU 22 is made to generate a state collecting command for detecting a state of the respective stream supplying apparatus connected onto the network and a stream transfer request for requesting transfer of the stream to the respective stream supplying apparatus.

CPU 22 stores information of the respective supply apparatus acquired by the state collecting command to an non-volatile memory 27 and generates various lists by using the stored information to accumulate to the non-volatile memory 27. A user I/F unit 24 is made to display a list display (user operating screen) based on the list accumulated to the non-volatile memory 27 on a display screen, not illustrated, and receive the operation of the user by a graphical user interface (GUI) by being controlled by CPU 22. Further, GPU 22 is also made to be able to generate a stream transfer request automatically to the stream supplying apparatus based on the list accumulated to the non-volatile memory 27.

Further, a program memory (P memory) 25 is stored with a program for realizing a processing of CPU 22.

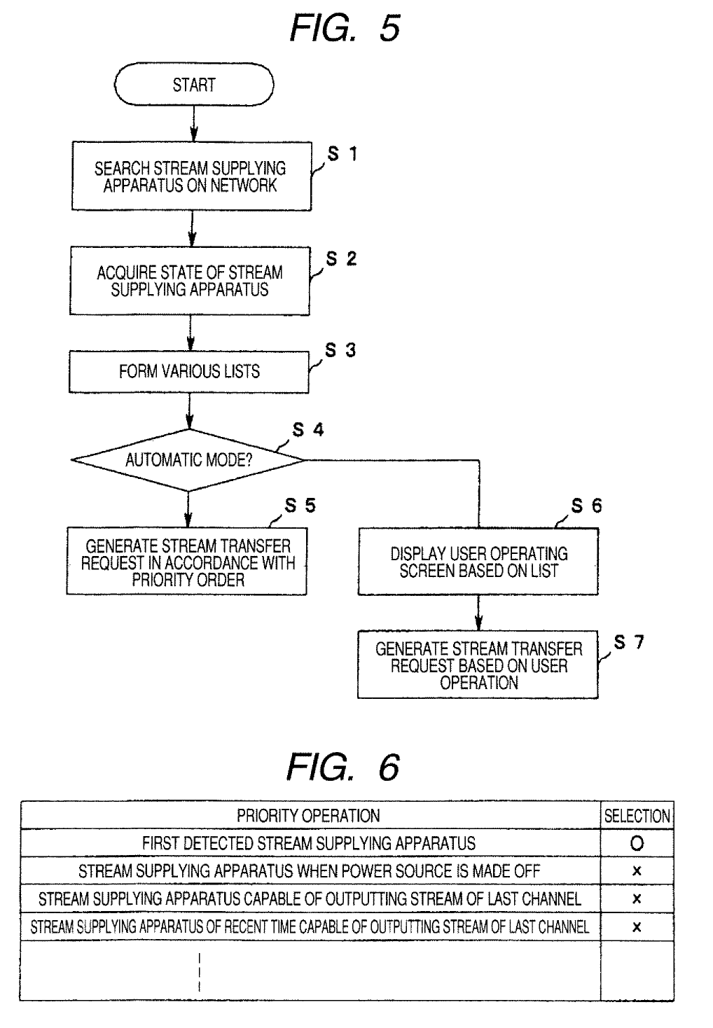

Next, an operation of the embodiment constituted in this way will be explained with reference to a flowchart of FIG. 5 and explanatory views of FIG. 6 through FIG. 9.

Now, assume that a power source of the content reproducing apparatus 52 is input. At step S1 of FIG. 5, the content reproducing apparatus 52 searches the stream supplying apparatus on the network after inputting the power source. That is, CPU 22 generates the state collecting command by being operated in accordance with a program stored to the P memory 25. The state collecting command is output onto the network by broadcasting by the network interface 21. The respective stream supplying apparatus on the network receive the state collecting command by way of the network interface 14. CPU 15 of the respective stream supplying apparatus returns responses to the received state collecting command. When the power source of the stream supplying apparatus is made OFF or the like, the stream supplying apparatus cannot execute reception of the state collecting command and response thereto and CPU 22 of the content reproducing apparatus 52 determines whether the power source of the stream supplying apparatus is made ON on the network by the response to the state collecting command.

Further, when the state collecting command is received, CPU 15 of the respective stream supplying apparatus read the information of the apparatus information memory 12 to output onto the network by way of the network interface 14. The information is received by the network interface 21 of the content reproducing apparatus 52. CPU 22 selects the information from the respective stream supplying apparatus to accumulate to the non-volatile memory 27 (step S2). Next, CPU 22 generates various lists based on the connected information (step S3).

Next, CPU 22 determines whether an automatic mode is set at step S4. When the automatic mode is set, CPU 22 is operated in accordance with information of priority operation stored in the non-volatile memory 27 or the like.

FIG. 6 shows the information of the priority operation. In the example of FIG. 6, there are registered 4 examples as priority operations, that is, that the stream is received from the first detected stream supplying apparatus in the search processing of step S1, that the stream is received from the stream supplying apparatus finally receiving supply of the stream when the power source of the content reproducing apparatus 52 is made OFF, that the stream is received from the stream supplying apparatus capable of outputting the stream of a channel the same as a channel (last channel) received when the power source of the content reproducing apparatus 52 is made OFF, and that the stream is received from the stream supplying apparatus recently receiving supply of the stream in the stream supplying apparatus capable of outputting the stream of the channel the same as the last channel.

Further, in the example of FIG. 6, it is shown that the operation of receiving the supply of the stream from the first detected supply apparatus is selected in the searching processing. Therefore, in this case, CPU 22 generates a channel selecting request and a stream transferring request to the stream supplying apparatus indicated by a result of searching of step S1.

For example, assume that the first detected stream supplying apparatus is the stream supplying apparatus 46. In this case, the requests are supplied to the stream supplying apparatus 46 from the network interface 21 by way of the wireless communication path 54, the relay apparatus 51 and the cable 53. The network interface 14 of the stream supplying apparatus 46 inputs the channel selecting request transmitted by way of the cable 53 to output to CPU 15. Thereby, CPU 15 controls the tuner 6 by way of I/F 9 to select a channel designated by a user. The tuner 6 selects the designated channel to output. The demodulator 7 acquires the transport stream of the content designated by the demodulating processing. The transport stream is accumulated to the memory 10 by CPU 15. CPU 15 outputs the stream read from the memory 10 to the content reproducing apparatus 52 by way of the network interface 14.

The content reproducing apparatus 52 inputs the stream of the content by way of the network interface 21, stores the stream to the memory 26, thereafter, supplies the stream to TSDMUX 23. TSDMUX 23 separates the image data and the voice data from the input stream to output to the video decoder 28 and the audio decoder 29. The video decoder 28 decodes the input image data and the audio decoder 29 decodes the input voice data.

The image signal from the video decoder 28 is supplied to the monitor 31 and the voice signal from the video decoder 29 is supplied to the speaker 33 by way of the amplifier 32. In this way, the content can be viewed and heard in accordance with the selected priority operation after inputting the power source.

On the other hand, at step S4, when it is determined that a manual mode is set, CPU 22 makes the processing proceed to step S6 and generates the list display by providing the list stored to the non-volatile memory 27 to the user I/F unit 24.

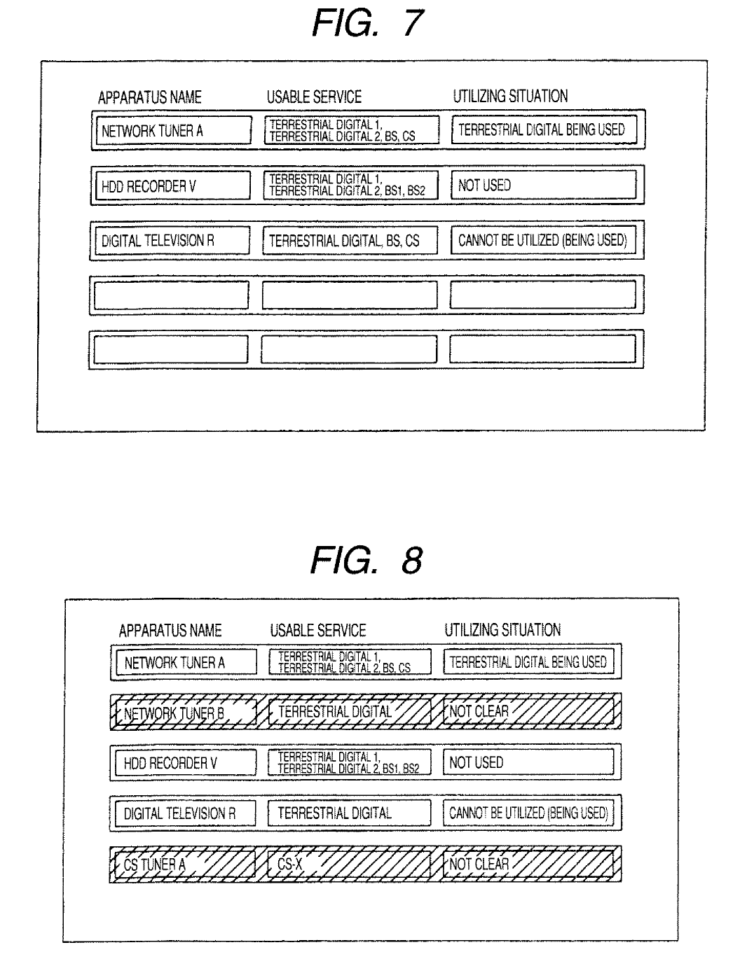

FIG. 7 shows an example of the list display. The example of FIG. 7 shows a name, a service, a utilizing situation of apparatus a power of which is made ON on the network. The example of FIG. 7 shows that, for example, the stream supplying apparatus 46 constituting the network tuner A, for example, the stream supplying apparatus 49 constituting a HDD decoder V and, for example, the stream supplying apparatus 48 constituting the digital television R are detected by the search processing at step S1. Further, for example, the network tuner A (stream supplying apparatus 46) can supply services of 2 routes of the terrestrial digital broadcast and the PS broadcast as well as the CS broadcast, and currently, 1 route of the terrestrial digital broadcast is being used. That is, it is shown that with regard to the network tuner A, the stream can further be adopted, at the content reproducing apparatus 52, the stream can be supplied by receiving 1 route of the terrestrial digital broadcast, BS broadcast or CS broadcast which is not being used.

Further, it is shown that by the list display, the HDD recorder V (stream supplying apparatus 49) can provide services of 2 routes of the terrestrial digital broadcast and 2 routes of BS broadcast, and is brought into a state of not being used currently, for example, a standby state, or is reproducing a recorded program. Further, it is shown that the digital television R (stream supplying apparatus 48) can provide services of 1 route of the terrestrial digital broadcast, the BS broadcast and the CS broadcast, is being used currently and cannot receive supply of the stream.

The user I/F unit 24 receives the operation of the user by displaying the list display on a display screen. For example, when the user designates the HDD decoder V, the user I/F unit 24 informs CPU 22 that the stream supplying apparatus 49 constituting the HOD recorder V is selected. CPU 22 generates a stream transfer request to the stream supplying apparatus 49. Thereby, the content reproducing apparatus 52 can visualize the content by receiving the stream from the stream supplying apparatus 49.

Meanwhile, when the power source of the stream supplying apparatus connected to the network is made OFF or the like, as described above, there is not the response to the state collecting command, and the information of the apparatus cannot be acquired from the stream supplying apparatus. Also in this case, it is conceivable that the apparatus information from the stream supplying apparatus is stored to the non-volatile memory 27 in the past. Hence, with regard to the stream supplying apparatus from which the information of the apparatus cannot be acquired when the power source is input, CPU 22 can also make the user I/F unit 24 form the list display by reading the past stored information stored to the non-volatile memory 27.

FIG. 8 shows an example of the list display in this case. The example of FIG. 8 adds information of, for example, the stream supplying apparatus 50 constituting the network tuner B and the stream supplying apparatus 47 constituting the CS tuner A to the example of FIG. 7. According to the stream supplying apparatus 47 and 50, when the power source of the content reproducing apparatus 52 is input, for example, power sources thereof are made OFF, and the user I/F unit 24 differentiates the stream supplying apparatus 47 and 50 from the currently usable stream supplying apparatus by a background color, a darkness of a character or the like (hatchings in FIG. 8).

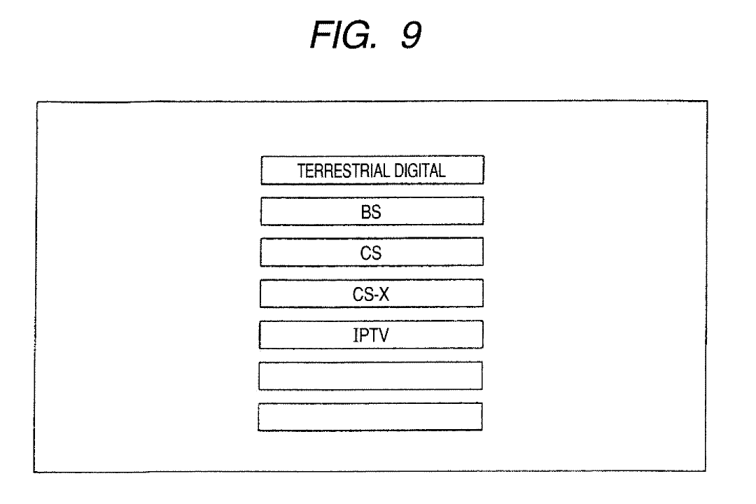

Further, the user I/F unit 24 can also generate other list display different from those of FIG. 7 and FIG. 8 based on the apparatus information stored in the non-volatile memory 27. FIG. 9 shows a service selecting display constituting an example of other list display. The display of FIG. 9 executes a display with regard to a usable service based on the apparatus information from the non-volatile memory 27. The user I/F unit 24 receives the operation of the user by displaying the list display on the display screen. For example, when the user designates BS, the user I/F unit 24 informs CPU 22 that the user desires to provide the service of BS.

In this case, CPU 22 generates the stream transfer request to the stream supplying apparatus which can utilize BS. When there are a plurality of the stream supplying apparatus which can utilize BS, CPU 22 can utilize, for example, the information of the priority operation of FIG. 6. CPU 22 can select the first detected stream supplying apparatus, the stream apparatus when the power source is made OFF, the stream supplying apparatus having a high frequency of being used in the past or the like in the stream supplying apparatus capable of utilizing BS in accordance with the information of the priority operation. CPU 22 outputs the stream transfer request to the selected stream supplying apparatus. Thereby, the content reproducing apparatus 52 can visualize the content by receiving the stream in accordance with the service designated by the user.

In the embodiment, the CPU 22 serves as a controller that selects one of the stream supplying apparatuses based on the apparatus information stored in the storage and controls the network interface to receive the data stream output from the selected stream supplying apparatus. In the embodiment, the user I/F unit 24 and the image processing unit 30 serve as a user interface that generates an image for notifying a status of the stream supplying apparatuses to a user based on the apparatus information stored in the storage.

As described above, according to the embodiment, the content reproducing apparatus can collect the state of the stream supplying apparatus connected onto the network and form the list when the power source is input. The content reproducing apparatus can receive supply of the stream by selecting the stream supplying apparatus automatically in accordance with the acquired list and broadcast service can be viewed and heard with no need of complicated operation immediately after inputting the power source. Further, the content reproducing apparatus can display the list display constituting the user operating screen in accordance with the acquired list. The user does not need to know beforehand what service can be provided by the apparatus on the network, and the service can be utilized currently, can know the information by the list display, and can operate to select the stream supplying apparatus on the GUI screen, and therefore, the apparatus is excellent in operability. Further, also the service which can be provided can be displayed by the list display, the user can simply view and hear the broadcast service simply by only selecting the service which is intended to provide without selecting the stream supplying apparatus and the apparatus is excellent in operability.

Further, according to the embodiment, it is apparent that the state of the stream supplying apparatus may be collected at any timing after inputting the power source of the content reproducing apparatus. Further, although an example of displaying the content of the service is shown as the list display, only the stream supplying apparatus to which the power source is input may be displayed by the list display.

Further, although according to the embodiment, the example of the network of predetermined communication standards has been explained, the network system is not limited but, for example, applicable to various networks for transmitting digital data of, for example, wireless LAN, IEEE1394, a telephone line, an electric lamp line, wireless or the like.

What is claimed is:

1. A stream supplying apparatus comprising:
a tuner that receives a broadcast signal;
a decoder that decodes the broadcast signal and outputs the decoded broadcast signal as a data stream;
a memory that stores apparatus information that pertains to the stream supplying apparatus; and
a network interface that transmits the apparatus information stored in the memory to a content reproducing apparatus, which is connected to the stream supplying apparatus via a network, in response to a state collecting command output from the content reproducing apparatus.

2. A content reproducing apparatus comprising:
a network interface that communicates via a network with a plurality of stream supplying apparatuses that output a data stream, the network interface receiving apparatus information that pertains to each of the stream supplying apparatuses from each of the stream supplying apparatuses;
a storage that stores the apparatus information received by the network interface;
a decoder that decodes the data stream received by the network interface to reproduce a content included in the data stream; and
a controller that selects one of the stream supplying apparatuses based on the apparatus information stored in the storage and controls the network interface to receive the data stream output from the selected stream supplying apparatus.

3. A content reproducing apparatus comprising:
a network interface that communicates via a network with a plurality of stream supplying apparatuses that output a data stream, the network interface receiving apparatus information that pertains to each of the stream supplying apparatuses from each of the stream supplying apparatuses;
a storage that stores the apparatus information received by the network interface;
a decoder that decodes the data stream received by the network interface to reproduce a content included in the data stream; and
a user interface that generates an image for notifying a status of the stream supplying apparatuses to a user based on the apparatus information stored in the storage.

4. A method for reproducing content, the method comprising:
communicating via a network with a plurality of stream supplying apparatuses that output a data stream to receive apparatus information that pertains to each of the stream supplying apparatuses from each of the stream supplying apparatuses;
storing the received apparatus information;
selecting one of the stream supplying apparatuses based on the stored apparatus information;
receiving the data stream output from the selected stream supplying apparatus; and
decoding the received data stream to reproduce a content included in the data stream.

5. A method for reproducing content, the method comprising:
communicating via a network with a plurality of stream supplying apparatuses that output a data stream to receive apparatus information that pertains to each of the stream supplying apparatuses from each of the stream supplying apparatuses;
storing the received apparatus information;
decoding the received data stream to reproduce a content included in the data stream; and
generating an image for notifying a status of the stream supplying apparatuses to a user based on the stored apparatus information.
